(19) United States
(12) Patent Application Publication
(10) Pub. No.: US 2017/0090893 A1
(43) Pub. Date: Mar. 30, 2017

(54) Interoperability of Transforms Under a Unified Platform and Extensible Transformation Library of Those Interoperable Transforms

(71) Applicant: Skytree, Inc., San Jose, CA (US)

(72) Inventors: Abhimanyu Aditya, San Jose, CA (US); Abhishek Gupta, San Jose, CA (US); Alexander Gray, Santa Clara, CA (US); Bradley Simmons, San Jose, CA (US); Maxsim Gibiansky, Sunnyvale, CA (US); Nicholas Ball, San Bruno, CA (US); Sanjay Mehta, Fremont, CA (US); Sergey Kirshner, Santa Clara, CA (US); Terison Gregory, Dublin, CA (US)

(21) Appl. No.: 15/279,868

(22) Filed: Sep. 29, 2016

Related U.S. Application Data
(60) Provisional application No. 62/234,517, filed on Sep. 29, 2015.

(51) Int. Cl. G06F 9/45; G06F 17/30

(52) U.S. Cl. CPC G06F 8/51; G06F 17/30569

(57) ABSTRACT

A system and method for facilitating interoperability of data transformations developed in different programming platforms under a unified platform including receiving a first transformation utilizing a first programming platform; receiving information about the first transformation; wrapping the first transformation; including the wrapped, first transformation in a transformation pipeline, the transformation pipeline including a second transformation that is wrapped, the second transformation utilizing a second programming platform different from the first programming platform; and executing the transformation pipeline including the wrapped, first transformation and the wrapped, second transformation in batch mode or real-time streaming mode.

### CROSS-REFERENCE FOR RELATED APPLICATIONS

The present application claims priority, under 35 U.S.C. §119, of U.S. Provisional Patent Application No. 62/234,517, filed Sep. 29, 2015 and entitled “Interoperability of Transforms Under a Unified Platform and Extensible Transformation Library of Those Interoperability Transforms,” which is incorporated by reference in its entirety.

### BACKGROUND OF THE INVENTION

1. Field of the Invention

The present invention is related to facilitating interoperability of transforms on datasets created using different programming platforms under a unified platform as well as building and managing an extensible library of transforms interoperable under a unified platform.

2. Description of Related Art

Users, such as data scientists, may have a preference or a familiarity with a particular platform and prefer to build transforms with the platform they are most familiar. For example, User A may prefer to build transforms using Python™, while User B may prefer to build transforms using another programming platform such as Apache Spark™ or R. User C may prefer to create certain kinds of transforms with Scala and others with R, using each programming platform for its strengths. However, when multiple users wish to collaborate or seek to use the work of others, the use of such heterogeneous programming platforms becomes problematic, since existing solutions fail to accommodate transforms developed using different programming platforms and fail to allow users to chain together two or more transformations that were built using different programming platforms (e.g. a user cannot combine a transform written in a Python™ script with another transform that uses Apache Spark™). In some cases, a user may have to convert individual transforms from one programming platform to another, which may be inefficient and time consuming. In other cases, a user may have to redevelop the transformations from the very beginning in a common programming platform in which the user(s) lacks skill. This could lead to the execution of the transformation pipeline on the dataset being a labor-intensive and a difficult process in the long run.

Thus, there is a need for a system and method that facilitates interoperability of transforms created using different programming platforms under a unified platform.

Existing solutions also fail to facilitate use of transforms created by other users. Particularly, existing solutions fail to facilitate the use of transforms created by other users where the transforms are built using a variety of different programming platforms. For example, present solutions fail to maintain a library and/or marketplace of transforms that a user may browse from, search through, use and combine regardless of the programming platform used to build the transform. Such a deficiency may lead to inefficiencies such as the unnecessary duplication or wasting of effort as a user may be unaware of a suitable transform already built by another user and build a new transform that may not perform as well.

Thus, there is a need for a system and method that creates an extensible transformation library, particularly an extensible transformation library in which interoperability of transforms in the library created using different programming platforms is facilitated in a unified platform.

### SUMMARY OF THE INVENTION

The present invention overcomes one or more of the deficiencies of the prior art at least in part by providing a system and method for facilitating interoperability of transforms under a unified platform and, in some embodiments, building an extensible transformation library of the interoperable transforms under a unified platform.

An innovative aspect of the subject matter described in this disclosure may be embodied in methods that include receiving a first transformation utilizing a first programming platform; receiving information about the first transformation; wrapping the first transformation; including the wrapped, first transformation in a transformation pipeline, the transformation pipeline including a second transformation that is wrapped, the second transformation utilizing a second programming platform different from the first programming platform; and executing the transformation pipeline including the wrapped, first transformation and the wrapped, second transformation in batch mode or real-time streaming mode.

According to another innovative aspect of the subject matter described in this disclosure, a system comprising one or more processors; and a memory storing instructions that, when executed by the one or more processors, cause the system to receive a first transformation utilizing a first programming platform; receive information about the first transformation; wrap the first transformation; include the wrapped, first transformation in a transformation pipeline, the transformation pipeline including a second transformation that is wrapped, the second transformation utilizing a second programming platform different from the first programming platform; and execute the transformation pipeline including the wrapped, first transformation and the wrapped, second transformation in batch mode or real-time streaming mode.

Other aspects include corresponding methods, systems, apparatus, and computer program products for these and other innovative features. These and other implementations may each optionally include one or more of the following features.

For instance, one or more of the first programming platform and the second programming platform is one of SAS™, Python™, Apache Spark™, PySpark, Java™, Scala, C++ and R.

For instance, the operations may include providing information about the transformation to schedule the transformation responsive to validating the pre-conditions and post-conditions of the transformation. For instance, the provided information about the transformation to schedule the transformation may include one from a group of usage scores, applicability scores and cost estimate.

For instance, the information about the first transformation includes metadata provided by a user regarding at least one input of the received, first transform and at least one output of the first transform, wherein the at least one input includes one or more of an input parameter, input data, an input data type and a precondition, and wherein the at least one output includes one or more of an output parameter, output data, an output data type and a post-condition.

For instance, the operations further include receiving a selection of the transformation pipeline; receiving a selection of the first transformation; identifying pre-conditions and post-conditions of the first transformation from the information about the first transformation; identifying a dataset of the transformation pipeline; validating the pre-conditions and post-conditions of the first transformation based on the dataset; and including the wrapped first transformation in the transformation pipeline based on the validation.

For instance, the first transformation includes a subset of one or more transformations from another transformation pipeline exported by a user.

For instance, the first transformation is developed using the first programming platform by a user and included in a transformation library.

For instance, the first transformation includes one or more from a group of machine learning model transformation, report transformation and plot transformation.

For instance the operations for receiving the selection of the transformation may further comprise receiving one or more search terms; retrieving tags associated with transformations from a transformation library; matching the one or more search terms against the tags; and retrieving a list of transformations from the transformation library.

The present invention is particularly advantageous because it facilitates interoperability of different transformations when executed in a data transformation pipeline. In particular such interoperability makes the data transformation pipeline directly optimizable. Another advantage of the approach is its natural ability to incorporate transformation from multiple users using various programming platforms for developing transformations and even validate the transformation pipeline apriori.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a block diagram of an embodiment of a system for building an extensible transformation library for interoperability of transforms under a unified platform in accordance with the present invention.

FIG. 2 is a block diagram of an embodiment of a transformation library server in accordance with the present invention.

FIG. 3 is a graphical representation of an embodiment of a user interface for submitting a transformation for inclusion in a transformation library.

FIG. 4 is a graphical representation of an embodiment of a user interface displaying a list of transformations retrieved responsive to a search for a transformation.

FIG. 5 is a graphical representation of an embodiment of a user interface for validating the transformation compatibility of a selected transformation in a transformation pipeline.

FIG. 6 is a graphical representation of an embodiment of a user interface displaying a directed acyclic graph view of the transformation pipeline associated with a dataset.

FIG. 7 is a graphical representation of an embodiment of a user interface displaying and exporting a sequence of transformations in the directed acyclic graph view of the transformation pipeline.

FIG. 8 is a flowchart of an example method for validating a transformation for inclusion in a transformation pipeline in accordance with the present invention.

FIG. 9 is a flowchart of an example method for retrieving a list of transformations matching a search for transformation in accordance with the present invention.

### DETAILED DESCRIPTION

A system and method for building an extensible transformation library for interoperability of transforms under a unified platform is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described in one embodiment below with reference to particular hardware and software embodiments. However, the present invention applies to other types of implementations distributed in the cloud, over multiple machines, using multiple processors or cores, using virtual machines, appliances or integrated as a single machine.

Reference in the specification to “one implementation” or “an implementation” means that a particular feature, structure, or characteristic described in connection with the embodiment is included in at least one implementation of the invention. The appearances of the phrase “in one implementation” in various places in the specification are not necessarily all referring to the same implementation. In particular the present invention is described below in the context of multiple distinct architectures and some of the components are operable in multiple architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is described without reference to any particular programming language. It will be appreciated that a variety of programming languages may be used to implement the teachings of the invention as described herein.

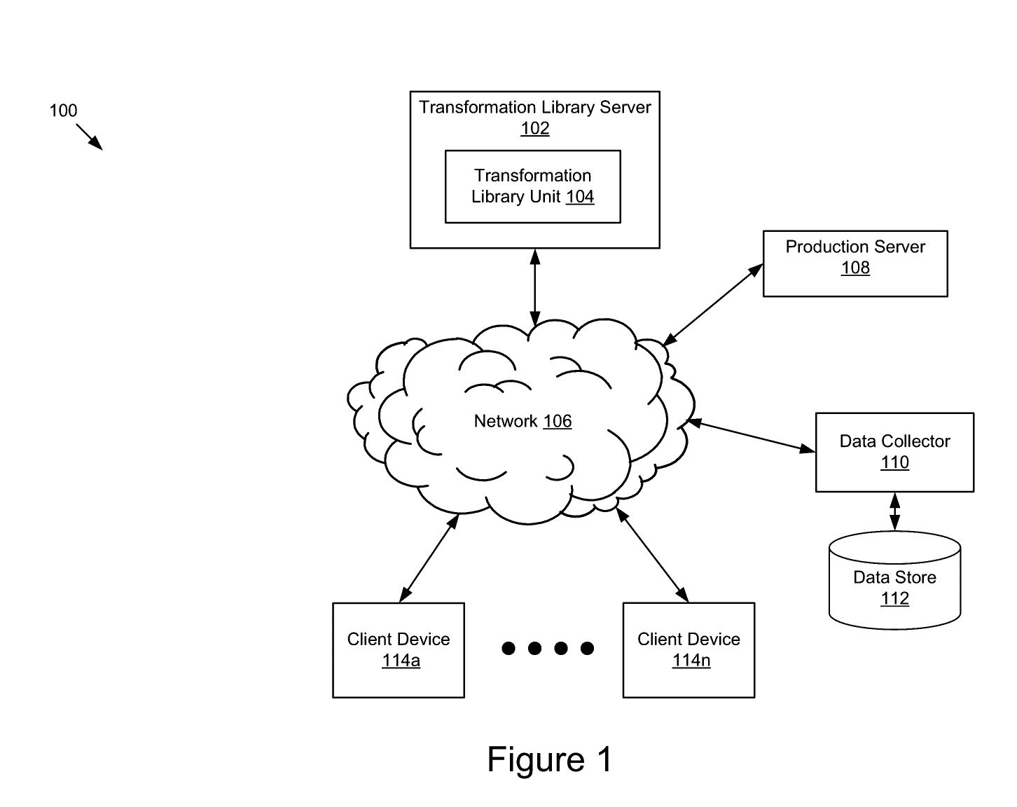

FIG. 1 shows an embodiment of a system 100 for building an extensible transformation library for interoperability of transforms under a unified platform. In the depicted embodiment, the system 100 includes a transformation library server 102, a plurality of client devices 114a . . . 114n, a production server 108, a data collector 110 and associated data store 112. In FIG. 1 and the remaining figures, a letter after a reference number, e.g., “114a,” represents a reference to the element having that particular reference number. A reference number in the text without a following letter, e.g., “114,” represents a general reference to instances of the element bearing that reference number. In the depicted embodiment, these entities of the system 100 are communicatively coupled via a network 106.

In some implementations, the system 100 includes a transformation library server 102 coupled to the network 106 for communication with the other components of the system 100, such as the plurality of client devices 114a . . . 114n, the production server 108, and the data collector 110 and associated data store 112. In some implementations, the transformation library server 102 may be a hardware server, a software server, or a combination of software and hardware. In the example of FIG. 1, the components of the transformation library server 102 may be configured to implement transformation library unit 104 described in more detail below. In some implementations, the transformation library server 102 provides services to data analysis customers by building an extensible transformation library for interoperable transforms. For example, the transformation library server 102 receives a transformation from a user, creates a representation of the transformation and stores the transformation as part of the transformation library in the storage device 212. For purposes of this application, the terms “transform,” “transformation” and “transform operation” are used interchangeably to mean the same thing, namely, a transformation used in the analysis of one or more datasets. Although only a single transformation library server 102 is shown in FIG. 1, it should be understood that there may be a number of transformation library servers 102 or a server cluster.

The production server 108 is a computing device having data processing, storing, and communication capabilities. For example, the production server 108 may include one or more hardware servers, server arrays, storage devices and/or systems, etc. In some implementations, the production server 108 may include one or more virtual servers, which operate in a host server environment and access the physical hardware of the host server including, for example, a processor, memory, storage, network interfaces, etc., via an abstraction layer (e.g., a virtual machine manager). In some implementations, the production server 108 may include a web server (not shown) for processing content requests, such as a Hypertext Transfer Protocol (HTTP) server, a Representational State Transfer (REST) service, or other server type, having structure and/or functionality for satisfying content requests and receiving content from one or more computing devices that are coupled to the network 106 (e.g., the transformation library server 102, the data collector 110, the client device 114, etc.). In some implementations, the production server 108 may include machine learning models, receive a transformation sequence for deployment from the transformation library server 102, use the transformation sequence on a test dataset (in batch mode or online) for data analysis, or any combination thereof.

The data collector 110 is a server which collects data and/or analysis from other servers (not shown) coupled to the network 106. In some implementations, the data collector 110 may be a first or third-party (i.e., associated with a separate company or service provider) server, which mines data, crawls the Internet, and/or obtains data from other servers. For example, the data collector 110 may collect user data, item data, and/or user-item interaction data from other servers and then provide it and/or perform analysis on it as a service. In some implementations, the data collector 110 may be a data warehouse or belonging to a data repository owned by an organization.

The data store 112 is coupled to the data collector 108 and comprises a non-volatile memory device or similar permanent storage device and media. The data collector 110 stores the data in the data store 112 and, in some implementations, provides access to the transformation library server 102 to retrieve the data collected by the data store 112. Although only a single data collector 110 and associated data store 112 is shown in FIG. 1, it should be understood that there may be any number of data collectors 110 and associated data stores 112. In some implementations, there may be a first data collector 110 and associated data store 112 accessed by the transformation library server 102 and a second data collector 110 and associated data store 112 accessed by the production server 108.

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another embodiment, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, WAP, email, etc.

The client devices 114a . . . 114n include one or more computing devices having data processing and communication capabilities. In some implementations, a client device 114 may include a processor (e.g., virtual, physical, etc.), a memory, a power source, a communication unit, and/or other software and/or hardware components, such as a display, graphics processor (for handling general graphics and multimedia processing for any type of application), wireless transceivers, keyboard, camera, sensors, firmware, operating systems, drivers, various physical connection interfaces (e.g., USB, HDMI, etc.). The client device 114a may couple to and communicate with other client devices 114n and the other entities of the system 100 via the network 106 using a wireless and/or wired connection.

A plurality of client devices 114a . . . 114n are depicted in FIG. 1 to indicate that the transformation library server 102 may receive transformations from, provide recommendations for transformations, and/or serve transformation pipeline information to a multiplicity of users on a multiplicity of client devices 114a . . . 114n. In some implementations, the plurality of client devices 114a . . . 114n may support the use of Application Programming Interface (API) specific to one or more programming platforms to allow the multiplicity of users to develop transform operations for analyzing a dataset and export the transform operations for representation in the transformation library.

Examples of client devices 114 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 114a and 114n are depicted in FIG. 1, the system 100 may include any number of client devices 114. In addition, the client devices 114a . . . 114n may be the same or different types of computing devices.

It should be understood that the present disclosure is intended to cover the many different embodiments of the system 100 that include the network 106, the transformation library server 102 having a transformation library unit 104, the production server 108, the data collector 110 and associated data store 112, and one or more client devices 114. In a first example, the transformation library server 102 and the production server 108 may each be dedicated devices or machines coupled for communication with each other by the network 106. In a second example, any one or more of the servers 102 and 108 may each be dedicated devices or machines coupled for communication with each other by the network 106 or may be combined as one or more devices configured for communication with each other via the network 106. For example, the transformation library server 102 and the production server 108 may be included in the same server. In a third example, any one or more of the servers 102 and 108 may be operable on a cluster of computing cores in the cloud and configured for communication with each other. In a fourth example, any one or more of one or more servers 102 and 108 may be virtual machines operating on computing resources distributed over the internet. In a fifth example, any one or more of the servers 102 and 108 may each be dedicated devices or machines that are firewalled or completely isolated from each other (i.e., the servers 102 and 108 may not be coupled for communication with each other by the network 106). For example, the transformation library server 102 and the production server 108 may be included in different servers that are firewalled or completely isolated from each other.

While the transformation library server 102 and the production server 108 are shown as separate devices in FIG. 1, it should be understood that in some embodiments, the transformation library server 102 and the production server 108 may be integrated into the same device or machine. Particularly, where they are performing online learning, a unified configuration may be preferred. While the system 100 shows only one device 102, 106, 108, 110 and 112 of each type, it should be understood that there could be any number of devices of each type. Moreover, it should be understood that some or all of the elements of the system 100 could be distributed and operate in the cloud using the same or different processors or cores, or multiple cores allocated for use on a dynamic as needed basis. Furthermore, it should be understood that the transformation library server 102 and the production server 108 may be firewalled from each other and have access to separate data collector 110 and associated data store 112. For example, the transformation library server 102 and the production server 108 may be in a network isolated configuration.

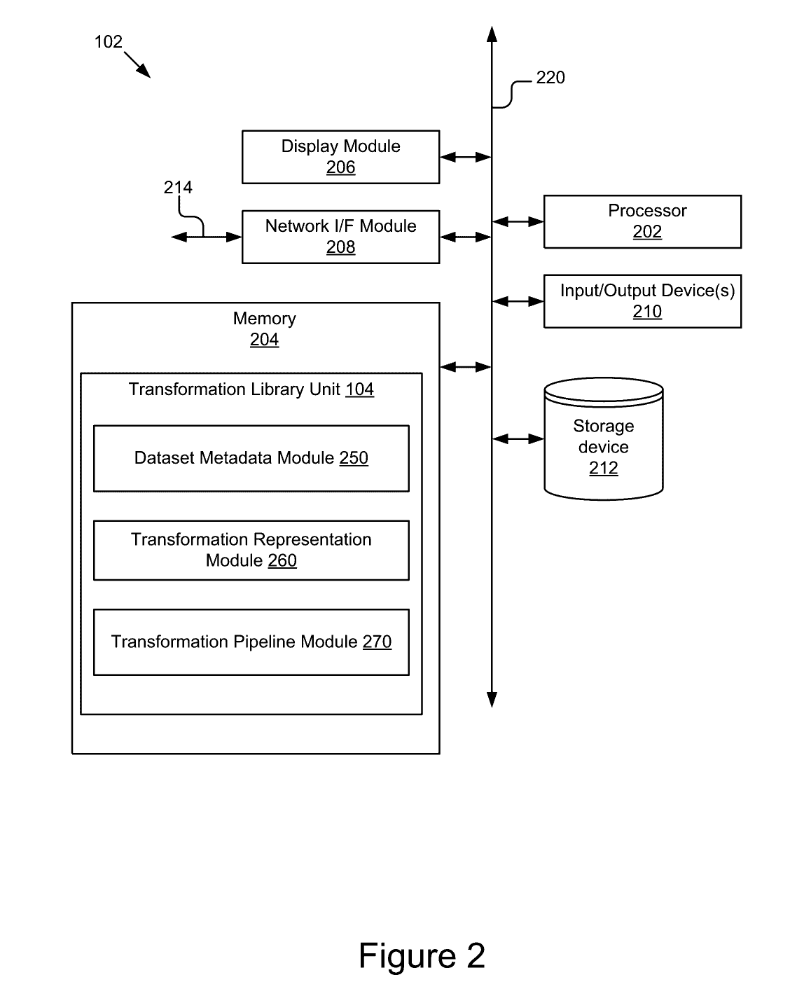

Referring now to FIG. 2, an embodiment of a transformation library server 102 is described in more detail. The transformation library server 102 comprises a processor 202, a memory 204, a display module 206, a network I/F module 208, an input/output device 210 and a storage device 212 coupled for communication with each other via a bus 220. The transformation library server 102 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the transformation library server 102 may include various operating systems, sensors, additional processors, and other physical configurations.

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays and physical configurations are possible. In some implementations, the processor(s) 202 may be coupled to the memory 204 via the bus 220 to access data and instructions therefrom and store data therein. The bus 220 may couple the processor 202 to the other components of the transformation library server 102 including, for example, the display module 206, the network I/F module 208, the input/output device(s) 210, and the storage device 212.

The memory 204 may store and provide access to data to the other components of the transformation library server 102. The memory 204 may be included in a single computing device or a plurality of computing devices. In some implementations, the memory 204 may store instructions and/or data that may be executed by the processor 202. For example, as depicted in FIG. 2, the memory 204 may store the transformation library unit 104, and its respective components, depending on the configuration. The memory 204 is also capable of storing other instructions and data, including, for example, an operating system, hardware drivers, other software applications, databases, etc. The memory 204 may be coupled to the bus 220 for communication with the processor 202 and the other components of transformation library server 102.

The instructions stored by the memory 204 and/or data may comprise code for performing any and/or all of the techniques described herein. The memory 204 may be a dynamic random access memory (DRAM) device, a static random access memory (SRAM) device, flash memory or some other memory device known in the art. In some implementations, the memory 204 also includes a non-volatile memory such as a hard disk drive or flash drive for storing information on a more permanent basis. The memory 204 is coupled by the bus 220 for communication with the other components of the transformation library server 102. It should be understood that the memory 204 may be a single device or may include multiple types of devices and configurations.

The display module 206 may include software and routines for sending processed data, analytics, or results for display to a client device 114, for example, to allow an administrator to interact with the transformation library server 102. In some implementations, the display module may include hardware, such as a graphics processor, for rendering interfaces, data, analytics, or recommendations.

The network I/F module 208 may be coupled to the network 106 (e.g., via signal line 214) and the bus 220. The network I/F module 208 links the processor 202 to the network 106 and other processing systems. The network I/F module 208 also provides other conventional connections to the network 106 for distribution of files using standard network protocols such as TCP/IP, HTTP, HTTPS and SMTP as will be understood to those skilled in the art. In an alternate embodiment, the network I/F module 208 is coupled to the network 106 by a wireless connection and the network I/F module 208 includes a transceiver for sending and receiving data. In such an alternate embodiment, the network I/F module 208 includes a Wi-Fi transceiver for wireless communication with an access point. In another alternate embodiment, network I/F module 208 includes a Bluetooth® transceiver for wireless communication with other devices. In yet another embodiment, the network I/F module 208 includes a cellular communications transceiver for sending and receiving data over a cellular communications network such as via short messaging service (SMS), multimedia messaging service (MMS), hypertext transfer protocol (HTTP), direct data connection, WAP, email, etc. In still another embodiment, the network I/F module 208 includes ports for wired connectivity such as but not limited to USB, SD, or CAT-5, CAT-5e, CAT-6, fiber optic, etc.

The input/output device(s) (“I/O devices”) 210 may include any device for inputting or outputting information from the transformation library server 102 and can be coupled to the system either directly or through intervening I/O controllers. The I/O devices 210 may include a keyboard, mouse, camera, stylus, touch screen, display device to display electronic images, printer, speakers, etc. An input device may be any device or mechanism of providing or modifying instructions in the transformation library server 102. An output device may be any device or mechanism of outputting information from the transformation library server 102, for example, it may indicate status of the transformation library server 102 such as: whether it has power and is operational, has network connectivity, or is processing transactions.

The storage device 212 is an information source for storing and providing access to data, such as a plurality of datasets, transformations and transformation pipeline associated with the plurality of datasets. The data stored by the storage device 212 may be organized and queried using various criteria including any type of data stored by it. The storage device 212 may include data tables, databases, or other organized collections of data. The storage device 212 may be included in the transformation library server 102 or in another computing system and/or storage system distinct from but coupled to or accessible by the transformation library server 102. The storage device 212 can include one or more non-transitory computer-readable mediums for storing data. In some implementations, the storage device 212 may be incorporated with the memory 204 or may be distinct therefrom. In some implementations, the storage device 212 may store data associated with a database management system (DBMS) operable on the transformation library server 102. For example, the RDBMS could include a structured query language (SQL) relational DBMS, a NoSQL DBMS, various combinations thereof, etc. In some instances, the DBMS may store data in multi-dimensional tables comprised of rows and columns, and manipulate, e.g., insert, query, update and/or delete, rows of data using programmatic operations. In some implementations, the storage device 212 may store data associated with a Hadoop distributed file system (HDFS) or a cloud based storage system such as Amazon™ S3.

The bus 220 represents a shared bus for communicating information and data throughout the transformation library server 102. The bus 220 can include a communication bus for transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the transformation library server 102 (operating systems, device drivers, etc.), and any of the components of the transformation library unit 104 may cooperate and communicate via a communication mechanism included in or implemented in association with the bus 220. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

As depicted in FIG. 2, the transformation library unit 104 may include and may signal the following to perform their functions: a dataset metadata module 250 that receives a dataset from a data source (for example, from the data collector 110 and associated data store 112, the client device 114, the storage device 212, etc.), processes the dataset to extract metadata and stores the metadata in the transformation library, a transformation representation module 260 that receives one or more transformations developed in different programming platforms from the client device 114, receives metadata relating to the transformations and adds the transformations to the transformation library, makes the transformations accessible through the transformation library and sends it to the transformation pipeline module 270, a transformation pipeline module 270 that receives a selection of a transformation for inclusion in a dataset transformation pipeline, performs a compatibility check on the connection of the transformation to the dataset transformation pipeline and exports a chain of transformations for execution on alternate datasets. These components 250, 260, 270, and/or components thereof, may be communicatively coupled by the bus 220 and/or the processor 202 to one another and/or the other components 206, 208, 210, and 212 of the transformation library server 102. In some implementations, the components 250, 260, and/or 270 may include computer logic (e.g., software logic, hardware logic, etc.) executable by the processor 202 to provide their acts and/or functionality. In any of the foregoing implementations, these components 250, 260, and/or 270 may be adapted for cooperation and communication with the processor 202 and the other components of the transformation library server 102.

The dataset metadata module 250 includes computer logic executable by the processor 202 to obtain (e.g. receive and/or retrieve) a dataset from various information sources, such as computing devices and/or non-transitory storage media (e.g., databases, servers, etc.). In some implementations, the dataset metadata module 250 obtains data from one or more of the servers 108, the data collector 110, the client device 114, and other content or analysis providers. For example, the dataset metadata module 250 obtains dataset from the data collector 110 and associated data store 112 on which the transformation library unit 104 is executing a transformation by sending a request to the data collector 110 via the network I/F module 208 and network 106. In another example, the dataset metadata module 250 obtains user data, item data, and/or interaction data from a third-party data source, such as a data mining, tracking, or analytics service. In some implementations, the dataset metadata module 250 scans the dataset independent of column order. For example, the dataset metadata module 250 may scan columns in an order independent of whether a column is of double data type or a column is of integer data type.

In some implementations, the dataset metadata module 250 scans the dataset to aggregate metadata present in the storage format of the dataset. For example, the dataset file may include a column name to identify a column, a type of the column to identify the column type and basic statistics about the columns in the dataset. In another example, the dataset file may include IDs, point weights, scoring weights, offsets, yield, group ID, etc. In a third example, the dataset attributes or metadata may include name, format, delimiter, array of columns, column attributes, index, categorical column type, ordinal column type, etc. In some implementations, the dataset metadata module 250 scans the received dataset represented in a row major data format. In other implementations, the dataset metadata module 250 scans the received dataset represented in a column major data format. For example, the dataset may be from a data source that favors Parquet data format and data is stored in a columnar fashion in the Parquet data format.

In some implementations, the dataset metadata module 250 determines metadata including the data type for the dataset. For example, the dataset metadata module 250 stores the syntactic data types of the columns in the data including Integer, Double, Text, Blob, DateTime, etc. as metadata. In another example, the dataset metadata module 250 stores the semantic data types. The semantic data types could be static type such as day of week, latitude/longitude, zip code, etc. The semantic data type could also be dynamically created by the user, such as a reading of a specific type of sensor. In some implementations, the dataset metadata module 250 stores rich metadata relating to the columns in the dataset. For example, the dataset metadata module 250 may identify a column of integers in the dataset to be associated with geo-spatial information of users. In another example, the dataset metadata module 250 may identify a column of text in the dataset to be associated with annotated Extensible Markup Language (XML) or JavaScript Object Notation (JSON).

In some implementations, the dataset metadata module 250 determines metadata including statistical information about the dataset. For example, the dataset metadata module 250 stores statistical information for all columns of the dataset such as number of items, number of missing items, etc. In another example, the dataset metadata module 250 stores statistical information (specific to numerical/continuous type columns) including min, max, mean, standard deviation, normal distribution, etc. and dictionaries (specific to categorical type columns).

In some implementations, the dataset metadata module 250 is coupled to the storage device 212 to store the aggregated metadata for the dataset in association with the transformation library in the storage device 212. The dataset metadata module 250 may be coupled to the transformation representation module 260, the transformation pipeline module 270 and/or other components of the transformation library server 102 to exchange information therewith. For example, the dataset metadata module 250 may store, retrieve, and/or manipulate the metadata aggregated by it in the storage device 212, and or may provide the metadata aggregated and/or processed by it to the transformation representation module 260 and the transformation pipeline module 270 (e.g., preemptively or responsive to a procedure call.). The metadata may provide a better understanding of the dataset for evaluating the applicability and/or compatibility of transformations to the dataset.

The transformation representation module 260 includes computer logic executable by the processor 202 to receive one or more transformations for inclusion in the transformation library. In some implementations, the transformation representation module 260 is coupled to the storage device 212 to represent the one or more transformations in the transformation library. The transformation library may be extensible to support and represent transformations developed in one or more different programming platforms. The transformations included in the transformation library may include machine learning specific transformations for data transformation. For example, the machine learning specific transformations include Normalization, Horizontalization (also known as “one hot encoding”), Moving Window Statistics, Text Transformation, supervised learning, unsupervised learning, dimensionality reduction, density estimation, clustering, etc. The transformation library may also support functional transformations that take multiple columns of the dataset as inputs and produce another column as output. For example, the functional transformations may include addition transformation, subtraction transformation, multiplication transformation, division transformation, greater than transformation, less than transformation, equals transformation, contains transformation, etc. for the appropriate types of data columns. In some implementations, the transformation pipeline module 270 may receive a request to delete models and/or datasets in the transformation workflow as a transformation to update the portion of the transformation workflow. In some embodiments, the execution of the transformations is “pushed down” to the database management system to the extent possible. For example, assume the dataset is maintained in one or more tables of a relational database and the transformation requires a join operation; in one embodiment, rather than importing the dataset in its entirety into the transformation library server 102 or production server 108 and performing the join operation there, the join operation is performed at the database thereby reducing the amount of data transmitted across the network 106 and facilitating memory-to-memory transfer of data, which is faster than transfers involving a read or write to disk.

Users interact with the REST API accessible via a client device 114 or a software development kit (SDK) installed on a client device 114, for example, to code the transformation in one or more programming languages. Users have a consistent view of the data through the API or SDK to program the transformation. For example, the programming platforms that may be used to develop transformations include, but are not limited to SAS™, Python™, SciPy, Apache Spark™, PySpark, R, Java™, Scala, etc.

In some implementations, the transformation representation module 260 registers the transformation developed by the user in the transformation library. In some implementations, the transformation represented in the transformation library may be a complex transformation composed of individual, simpler transformations. For example, a user-developed transformation may be composed of column extraction transformation, column addition transformation, column subtraction transformation, etc. In another example, the transformation can be a subset of one or more transformations from a data transformation pipeline, which may also occasionally be referred to herein as a transformation workflow, project workflow or similar, exported by a user. Thus, in some implementations, a transformation may be a pipeline and thus pipelines can include pipelines (which are transforms). In other words, a transformation can be a pipeline and its recursive in some implementations. In some implementations, the transformation represented in the transformation library may be a machine learning model that can be an input to another transformation in a transformation pipeline. In other implementations, the transformation may be a report transformation and/or a plot transformation. The report transformation and/or the plot transformation may connect to the output of the transformation for a model and generate report(s) and/or plot(s) for a transformation pipeline applied to a dataset. The transformations registered in the transformation library may be exported to be reusable on alternate datasets that may be larger and distributed even though the registered transformations may not have been developed with those intentions or capabilities.

In some implementations, the transformation representation module 260 collects information and metadata relating to the one or more transformations to associate with the one or more transformations for a well-defined representation in the transformation library. For example, the transformation representation module 260 associates information such as a name and a description of the transformation in the transformation library. The description of the transformation may include user consumable information describing the functionality of the transformation. In some implementations, the representation of the transformation in the transformation library may allow linking the transformation to a descriptive knowledge base (e.g., a help page). A user intending to use the transformation may review one or more of the collected information and metadata relating to a transformation and learn the consequences of invoking the transformation within a dataset transformation pipeline.

In some implementation, the transformation representation module 260 associates metadata including, but not limited to, one or more of a list of input and output datasets (e.g. columnar data or features) expected as inputs and outputs of the transformation, a list of input and output parameters for executing the transformation (e.g. when the transformation is a machine learning algorithm), sample data to be used for the transformation, transformation steps (i.e., simpler transformations combined to form the complex transformation) and the attributes of the simple transformations combined, data types (e.g. primitive or user-defined) of the input and output datasets and parameters and pre-conditions and post-conditions for a well-defined representation of the transformation in the transformation library. The pre-conditions and the post-conditions of the transformation are based on the input and output data associated with executing the transformation. For example, the transformation may have a pre-condition indicating that columnar data or a constraint such as feature A must be numeric and less than zero. In another example, the transformation may have a pre-condition that the transformation accepts a feature A of integer data type and feature B of double data type as input and the post-condition may be that the transformation outputs a feature C of double data type. In some implementations, the transformation representation module 260 may receive information and metadata relating to the one or more transformations from the user that developed the transformation.

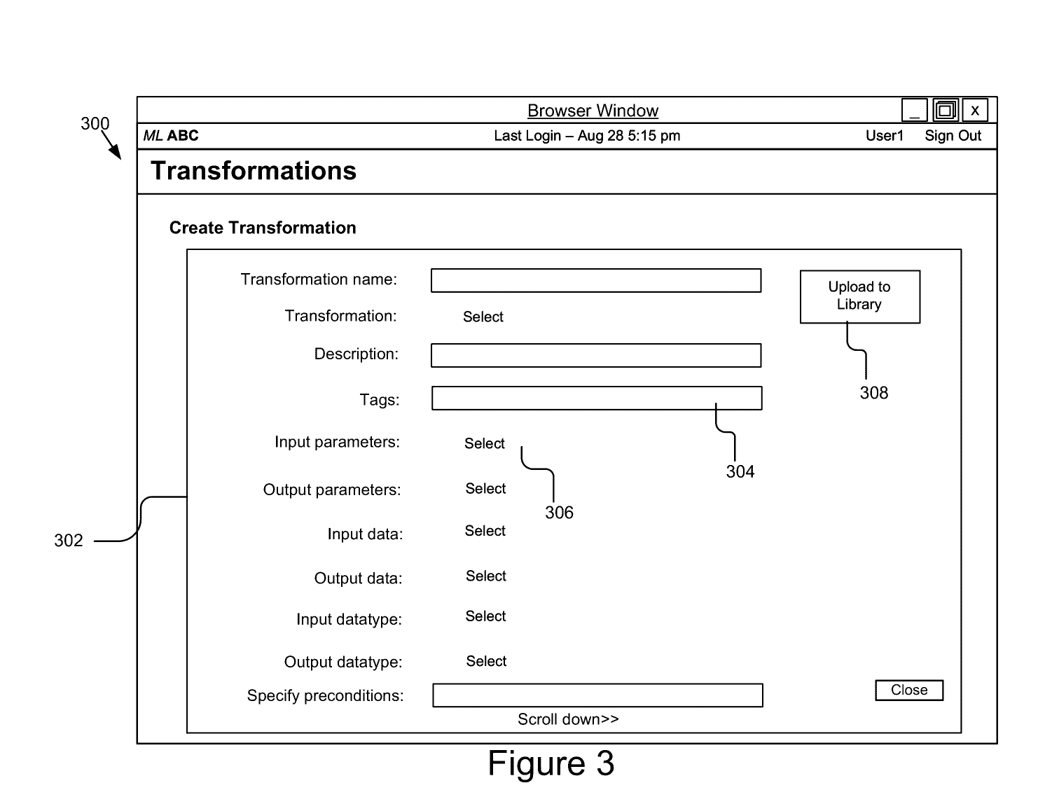

In some implementations, the transformation representation module 260 receives metadata associated for a well-defined representation of the transformation in the transform library by user input, parsing the transform or a combination thereof. For example, in one implementation, the transformation representation module 260 receives metadata via a user interface such as the one discussed below with reference to FIG. 3. In another example, in one implementation, the transformation representation module will parse the code of the transform (e.g. parse the Python™ script or R script) and receive metadata based on the parsing.

In some implementations, the transformation representation module 260 wraps the transform for inclusion of the transformation in the transform library. For example, the transformation representation module 260 is capable of wrapping the transform whether written using SAS™, Python™, Apache Spark™, PySpark, R, Java™, Scala, C++ or some other programming language or platform for inclusion in the transform library and combination with other transforms including transforms that utilize a different programming platform if the user so desires, thereby beneficially providing a programming platform agnostic, unified transformation platform. In some implementations, wrapping the transform abstract the transform written using a programming language or platform for user with other transforms, which may not be written using the same programming language or platform.

In one embodiment, the transformation representation module 260 module wrapping the transform for inclusion includes automatically generating logic, which may be referred to as “glue logic,” that allows the transformation, which is written using a first programming language or platform, to work with other transformations, such as a preceding or succeeding transform, which may be written using one or more other programming languages or platforms (i.e. may be heterogeneous). For example, in one embodiment, the transformation representation module 260 obtains (e.g. automatically or from a user) one or more of the inputs, outputs and parameters of a transformation to be wrapped by the transformation representation module 260 and wraps that transformation by generating glue logic. Depending on the implementation, the glue logic may be programming language or platform dependent (i.e. depends on the programming language or platform of one or more of the transform being wrapped, a preceding transformation and a succeeding transformation) or may be programming language or platform agnostic. It should be recognized that the glue logic may include modification or replacement of portions of the transformation being wrapped.

In some embodiments, the transformation representation module 260 generates the glue logic prior to including the transform in the transformation library. For example, assume a transform using Python™ is to be included in the transformation library; in some implementations, the transformation representation module 260 may generate glue code for that transformation prior to including that transformation in the transformation library. In some embodiments, the transformation representation module 260 generates the glue logic when the transform is inserted into a transformation pipeline. For example, the transformation representation module 260 may generate glue code for that transformation prior to including that transformation in the transformation pipeline (e.g. in implementations where the glue code may depend on a programming language or platform of a preceding or succeeding transformation).

In some implementations, when the transformation representation module 260 wraps a transformation, the transformation representation module 260 creates two versions of the transformation—a batch version and a real-time version. For example, the transformation representation module 260 generates a batch version for transforming batch data (e.g. for use during training) and a real-time version (e.g. for use during deployment on individual data instances received in real-time or near real-time).

In some implementations, the transformation representation module 260 may provide transformation authoring functionality. In some implementations, the transformation representation module 260 receives user input identifying one or more input parameters, one or more output parameters, one or more input datasets, one or more output datasets, one or more output plots, one or more output reports, one or more output models or a subset of the aforementioned parameters, datasets, plots, reports and models, and generates the logic for the transform and that transformation may be added to the transformation library. For example, assume the transformation is to represent an interest rate as a percentage; in one implementation, the transformation representation module 260 receives user input indicating that column “rate” should be multiplied by 100 and perhaps that the output should be a new “percent interest” column and automatically generates, for the user, the logic to perform or implement such a transformation.

In some implementations, the transformation representation module 260 generates tags for the one or more transformations to allow easy identification of connection compatibility between different transformations of a data transformation pipeline. The transformation representation module 260 may generate the tags for a transformation based on identification and meta-analysis of key input and output features of the transformation. The tags may indicate certain dependencies of the transformation. The tags for the one or more transformations may be used for classifying the transformations. In some implementations, the transformation representation module 260 organizes the tags in a namespace of the transformation library to allow an extensible vocabulary for different types of transformations where some are interchangeable and some are semantically distinct from others. For example, the transformations can be organized in the transformation library as data cleansing transformations, extract-transform-load (ETL) transformations, feature generation transformations, time series transformations, feature selection transformations, model generation transformations, prediction transformations, report transformations, plot transformations, etc. In some implementations, the transformation representation module 260 organizes the tags in a hierarchical fashion to support the hierarchical organization or categorization of transformations in the transformation library. For example, the transformations for supervised model generation and unsupervised model generation may be categorized under model generation transformation.

Depending on the implementation, a transformation library may be private, public or a combination thereof. For example, in some implementations, each user, set of users or account may have its own transformation library and the transformation library may be private and accessible only to that user or set of users through that account. In another example, the transformation library may include a private portion in which the user may keep one or more transformations private from other users (e.g. other users and/or account cannot access or use those private transformations) and a public portion in which the user may keep one or more transformations that the user is willing to share with other users and allow other users to use. In some implementations, whether and to what degree a transformation library of an individual user or account is private or public is controlled by one or more preference settings. In some implementations, the preference settings may allow for granular control (e.g. allowing the user to control the availability of each individual transformation associated with the user/account).

In some implementations, the transformation library, which may by searchable/discoverable, may serve as a transformation community where users may share their transformations with the community and/or use transformations made available by other users of the community thereby facilitating collaboration and eliminating duplication of effort. In some implementations, the transformation library may serve as a marketplace where users may offer their transformations to other users in exchange for a monetary or non-monetary reward.

In some implementations, the transformation representation module 260 aggregates, over a period of time, metadata associated with the use and application of the transformations available in the transformation library. For example, the transformation representation module 260 identifies how a transformation is performing, when the transformation is used and how useful the transformation is for application to a particular task. The transformation representation module 260 generates usage scores and applicability scores for the transformations in the transformation library. For example, the usage scores and the applicability scores can be based on the popularity and the frequency of use of the transformations. In some implementations, the transformation representation module 260 determines a cost estimate for the transformation. The cost estimate provides a hint of the cost associated with the transformation. For example, the time and resources (e.g. processor cycles, memory, kilowatt hours, etc.) that may be spent and/or used if the transformation is invoked in a dataset transformation pipeline. Such information can be used by a user to appropriately schedule the transformation for invocation on the dataset transformation pipeline (e.g. to schedule invocation after 9 PM due to lower (off peak) electricity rates based on high kilowatt hour rating, to schedule a processor intensive transformation when processor utilization is historically lower, etc.).

In some implementations, the transformation representation module 260 receives a search request for a transformation from the transformation pipeline module 270. For example, the search request may include one or more search terms from the user searching for a transformation. The transformation representation module 260 retrieves tags from the transformation library. The transformation representation module 260 matches the one or more search terms with the tags from the transformation library. The transformation representation module 260 retrieves a list of transformations responsive to the one or more search terms matching the tags of the transformations and provides the list of transformations to the transformation pipeline module 270. The list of transformations retrieved by the transformation library may be ranked according to the usage scores, applicability scores or any other score.

The transformation pipeline module 270 includes computer logic executable by the processor 202 to receive a selection of a transformation and process and determine a validation of transformation compatibility for introduction in a transformation pipeline of a dataset. In some implementations, the transformation pipeline module 270 is coupled to the storage device 212 to access one or more transformations in the transformation library, retrieve metadata for validating the pre-conditions and post-conditions during a transformation compatibility check and export a new transformation to the transformation library.

In some implementations, the transformation pipeline module 270 determines a sequence of transformations that have been applied to the dataset from the beginning in the transformation pipeline. For example, the transformation pipeline module 270 maintains a history of user actions in the form of transformations that have been invoked on the transformation pipeline of the dataset and, upon request, presents a user the evolution of the transformation pipeline thereby facilitating auditing of the transformation pipeline. In some implementations, the transformation pipeline may include an iteration at a level between the datasets and models. For example, the transformation pipeline can be a mixture of experts model setup and feature generation/selection performed inside a cross-validation structure. In some such implementations, the transformation pipeline include a single graphical element to represent an iteration. For example, assume the data is split 10 times for validation; in one implementation, the DAG may include a single graphical element representing those splits in order to keep the presentation clean and, in some implementations, the user may optionally zoom in on the transformation represented by that single graphical element to see the subcomponents. In another example, assume feature selection is performed in which one or more columns are eliminated at a time from the dataset and a model is trained each time with different column(s) missing in order to find the feature set that results in the most accurate model; in one implementation, the DAG may include a single graphical element representing the feature selection in order to keep the presentation clean and, in some implementations, the user may optionally zoom in on the transformation represented by that single graphical element to see the subcomponents.

The transformation pipeline module 270 generates instructions for a visual representation of the transformation pipeline in the form of a directed acyclic graph (DAG) view according to one embodiment. The DAG view tracks the execution history (i.e., date, time, etc.) of various transformations applied to the dataset in the transformation pipeline. For example, the DAG view may simplify the audit trail of the data flow and transformation sequence through the transformation pipeline at different points. In some implementations, the transformation pipeline module 270 may receive a request to instantiate a DAG of a transformation pipeline, or portion thereof, as an individual transformation. With DAG of the transformation pipeline modularized as a transformation by itself, the user may create a hierarchical DAG of a complex transformation pipeline from portions of an existing DAG for other transformation pipelines.

In some implementations, the DAG view of the transformation pipeline can be manipulated by the user to select a subset of one or more transformations in the transformation pipeline of a first dataset. The transformation pipeline module 270 may receive a request from the user to export the subset of one or more transformations as a new transformation to the transformation library. For example, in the DAG view, the user can choose to collapse a portion or a subset of the transformation pipeline into a single node and provide a name for it. In some implementations, the transformation pipeline module 270 sends instructions to the transformation representation module 260 to register the newly named transformation in the transformation library. The new transformation can then be reapplied on a second dataset that can be different from the first dataset. For example, the subset of the transformation pipeline used in a scenario such as churn, fraud, risk analysis, etc. could serve as a pluggable transformation sequence that can be reused in other scenarios and/or by other users. In another example, the transformation sequence could be used as part of a much larger transformation effort on another dataset. In a third example, the transformation sequence can be exported and invoked on a test dataset in a production environment.

In some implementations, the transformation pipeline module 270 receives a user request to invoke a transformation in a dataset transformation pipeline. The transformation pipeline module 270 accesses the transformation library to retrieve metadata relating to the dataset and pre-conditions and post-conditions of the transformation. For example, the transformation pipeline module 270 determines constraints of the input data needed and the output produced by the transformation. The transformation pipeline module 270 determines that the pre-condition for the transformation indicates that a feature needed for the transformation should be of integer data type and that the post-condition indicates that a feature resulting as an output of the transformation would be of double data type. The transformation pipeline module 270 evaluates whether the transformation is applicable to one or more columns of the dataset by validating the transformation compatibility based on the metadata of the dataset and pre-conditions and post-conditions of the transformation. In some implementations, the transformation pipeline module 270 may validate the transformation compatibility prior to including the transformation in the transform pipeline. In some implementation, the transformation pipeline receives a request to search for a transformation from the user, sends the request to the transformation representation module 260 and receives a list of transformations matching the search request from the transformation library.

In some implementations, the transformation pipeline module 270 provides feedback to the user responsive to evaluating the validation of transformation compatibility. The transformation pipeline module 270 includes the transformation in the transformation pipeline. For example, if the transformation is found compatible, the transformation pipeline module 270 retrieves information about the transformation from the transformation library. For example, the information retrieved may include usage scores and applicability scores for presentation to a user. In another example, the information may indicate that the transformation can be applied on a per data point basis (row of the dataset). This provides enough information to deploy the transformation in a production environment where the live data is streamed in a row (or one data point) at a time. In another example, if the transformation is found to be incompatible, then the transformation pipeline module 270 provides information relating to why it is found incompatible (e.g. “Your dataset uses strings, which are not compatible with one or more of the functions used by this transform”), a suggestion of an alternate transformation that may be suited for the task (e.g. “Please consider the transform by the name of [alternate transform name here] instead), corrective action to be taken (e.g. “Please include a transform in which you convert column X into an integer data type”) or a combination thereof.

In some implementations, the transformation pipeline module 270 monitors the execution of the transformation in the transformation pipeline and aggregates performance statistics and metrics for the transformation. For example, progress metrics, usage metrics, error or failure metrics, etc. For example, the transformation pipeline module 270 determines progress and usage metrics to indicate how the transformation is coming along, at what stage of the transformation pipeline, the speed of the transformation in processing the data and the amount of time spent for the transformation operation.

In another example, the transformation pipeline module 270 determines error or failure metrics to indicate whether the transformation operation was successful, successful in part or failed completely at execution time. Due to distributed configuration of datasets, the transformation pipeline module 270 may fail to read records of the data during the execution of the transformation. In some implementations, the transformation pipeline module 270 determines a percentage of errors or failures occurring during the execution of the transformation and provides a notification to the user if the percentage exceeds a threshold. For example, if the execution of the transformation indicates a 70%-80% failure, then the transformation pipeline module 270 generates a notification. In some implementations, the threshold for notification may be set by the user at the time of execution of the transformation operation.

FIG. 3 is a graphical representation 300 of an embodiment of a user interface for submitting a transformation for inclusion in a transformation library. In the graphical representation 300, the user interface includes a form 302 for entering information relating to submitting a transformation. The form 302 includes fields such as that indicated 304 for Tags and select buttons such as that indicated 306 for input parameters. In one embodiment, the fields and buttons are used to enter metadata information including a name, a transformation (e.g. via a file path to the transform's file), a description, tags, input parameters, output parameters, input data, output data, input datatype, output datatype, pre-conditions and post-conditions, etc. associated with the transformation. The form 302 includes an “Upload to library” button 308 which the user can select to submit the transformation and associate the metadata information to represent the transformation in the transformation library.

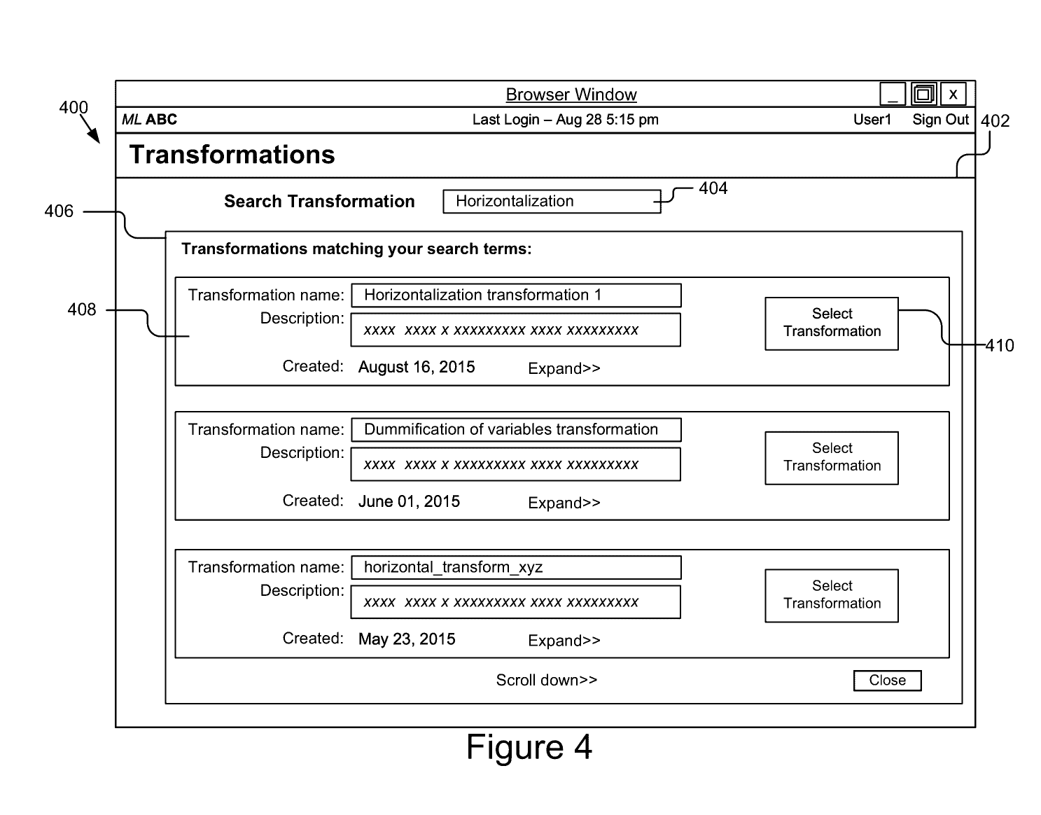

Referring to FIG. 4, a graphical representation 400 of an embodiment of a user interface for displaying a list of transformations retrieved from a transformation library in response to a search for a transformation. In the graphical representation 400, the user interface includes a search page 402 for a user to search for a transformation. The search page 402 includes a search box 404 where the user inputs one or more search terms. In the graphical representation 400, as an example, the search term input is “Horizontalization.” The search page 402 includes a list 406 of transformations retrieved as results matching the search term “Horizontalization.” Each of the illustrated search results 408 includes the name of the transformation, a description, a date of creation, etc. for the user deciding to select a transformation from the list 406. However, it should be understood that the search results may include other information depending on the implementation and that such other information is within the scope of this disclosure. The search result 408 includes a “Select Transformation” button 410 which the user can select to retrieve the transformation for inclusion in a transformation pipeline and application to a dataset.

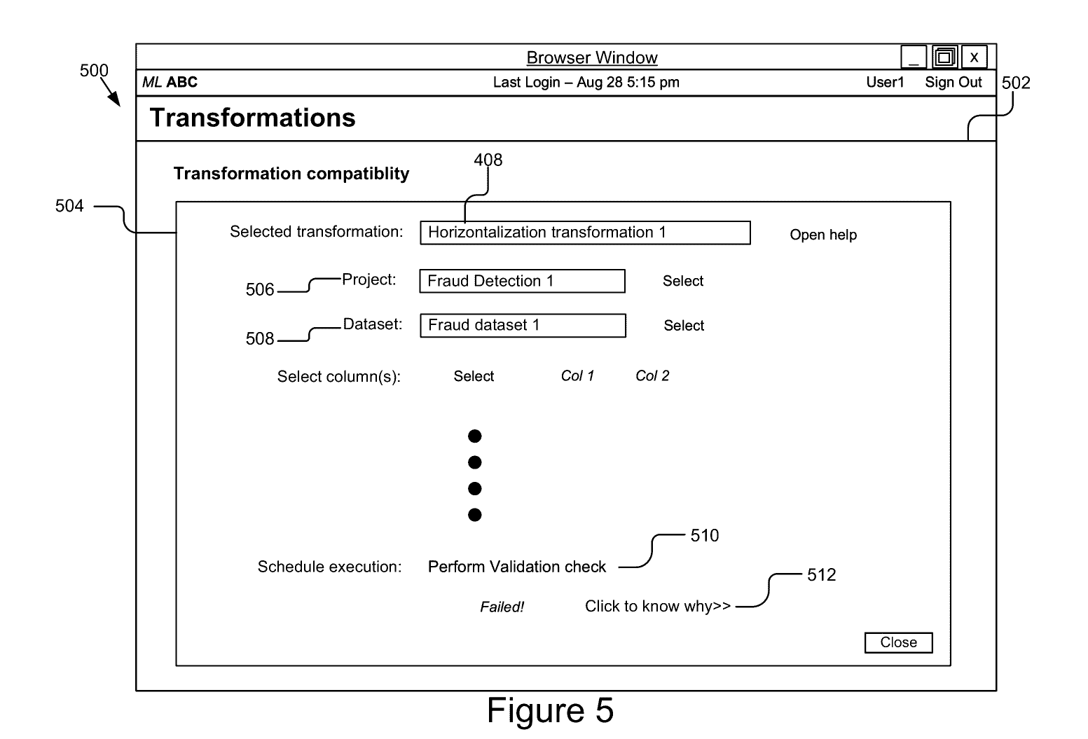

Referring to FIG. 5, a graphical representation 500 of an embodiment of a user interface for validating the transformation compatibility of a selected transformation in a transformation project. In the graphical representation 500, the user interface includes a validation page 502 for validating whether the transformation is applicable to one or more columns of the dataset in a project pipeline. The validation page 502 includes a form 504 to be filled with information regarding the transformation computability. The form 504 includes a selected transformation 408, e.g., from FIG. 4. The user can select a transformation project and enter it under the project field 506. Similarly, the user can select a dataset and enter it under the dataset field 508. When the form 504 is sufficiently populated, the user can check the transformation compatibility by selecting the “perform validation check” button 510. In the graphical representation 500, as an example, it is shown that the validation check failed. The user can select the “Click to know why” link 512 to understand the reason why the transformation is incompatible.

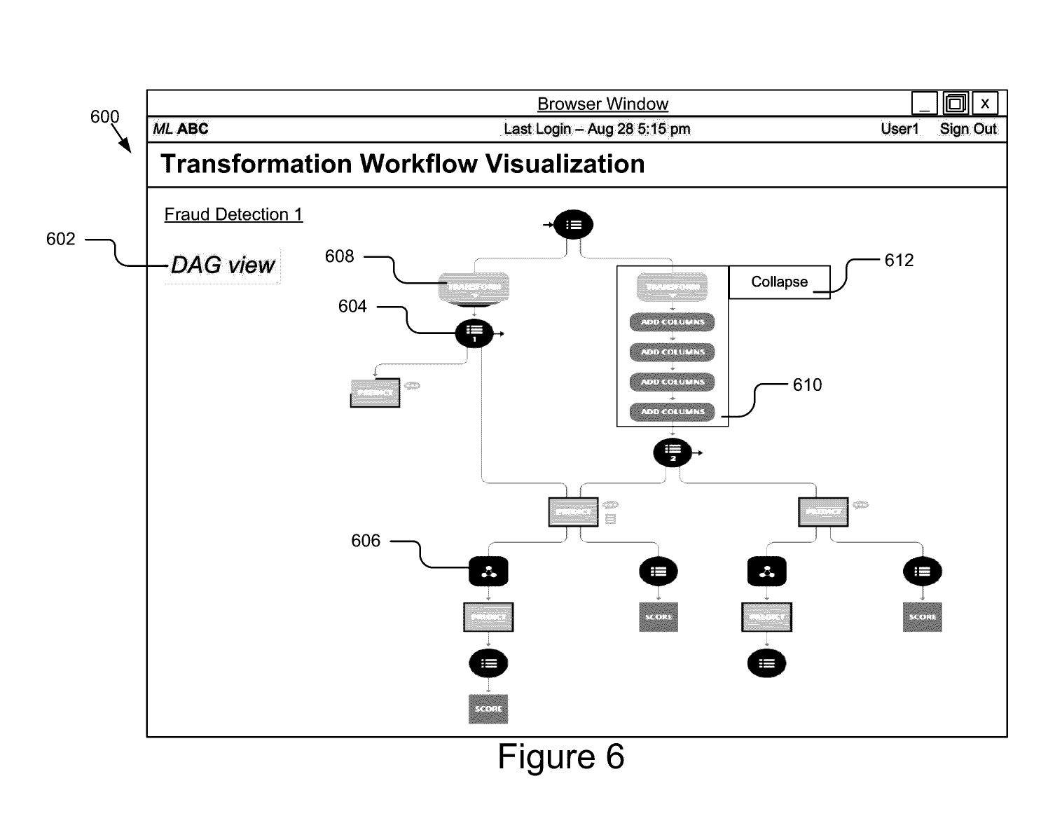

Regarding FIG. 6, a graphical representation 600 of an example embodiment of a user interface for displaying a DAG view of the transformation pipeline associated with a dataset is shown. In the graphical representation 600, the user interface includes a DAG view 602 of transformation pipeline. The nodes of the DAG represent the datasets 604, models 606, plots (not shown), reports (not shown), etc. The edges of the DAG represent the transformations 608 between the nodes of the DAG. In the graphical representation 600, as an example, the DAG view 602 includes a sequence of transformations 610 which the user can drag and select as shown. The user can choose to collapse this sequence into a node to create a new transformation by selecting the “Collapse” button 612.

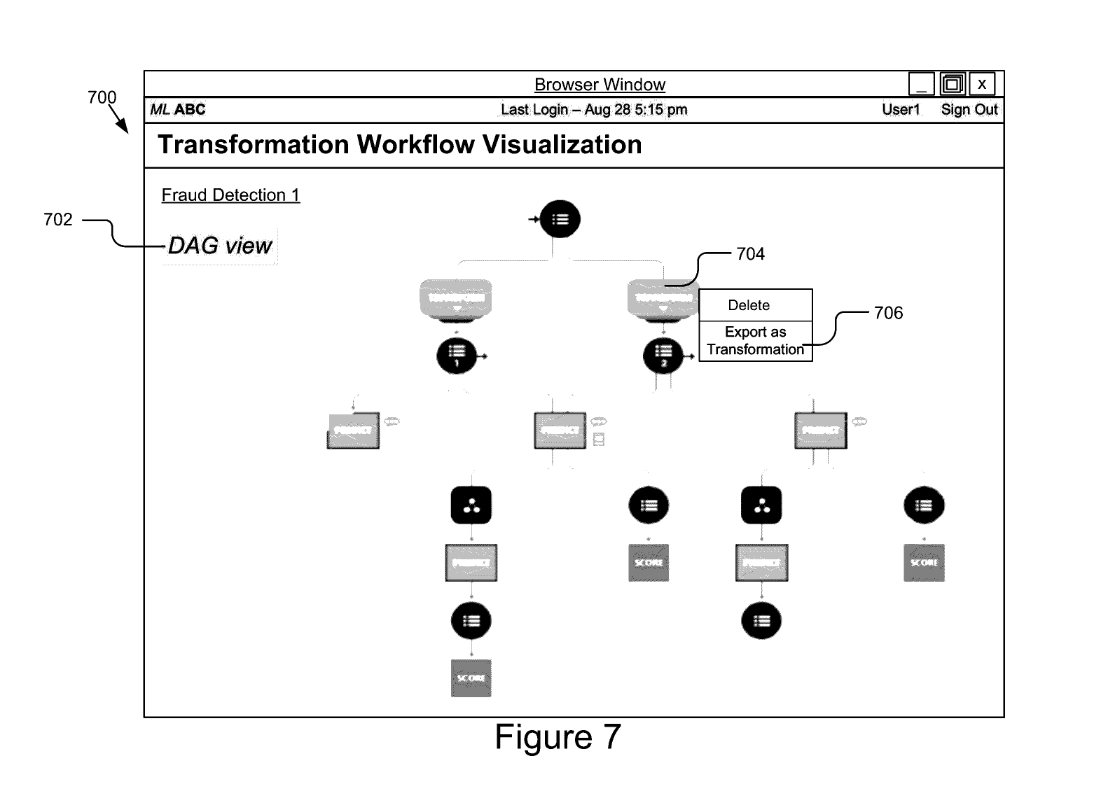

Now refereeing to FIG. 7, a graphical representation 700 of an embodiment of a user interface for displaying and exporting a sequence of transformations in the directed acyclic graph view of the transformation pipeline. In the graphical representation 700, the user interface includes an updated view of the DAG 702 as a result of the user selecting the “Collapse” button 612 in FIG. 6. The DAG view 702 shows the collapsed node 704. The user can then choose to export the new transformation to the transformation library by selecting “Export as transformation” button 706. It should be understood that the data discussed in reference to and represented in FIGS. 3-7 is provided as an example, is not intended to be limiting, and other data and data types are possible and contemplated in the techniques described herein.

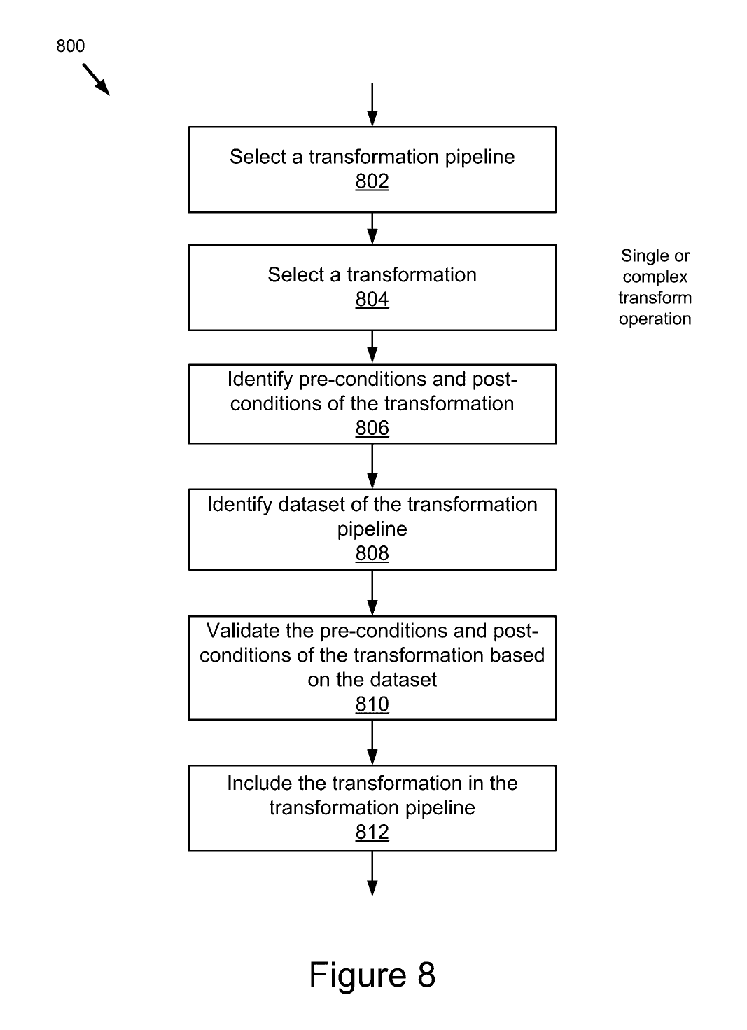

FIG. 8 is flowchart of an example method 800 for validating a transformation for inclusion in a transformation pipeline. At 802, the transformation pipeline module 270 selects a transformation pipeline. In some implementations, the transformation pipeline module 270 receives a user request including a selection of a dataset transformation pipeline. For example, the transformation pipeline could be associated with analyzing a transformation project or pipeline such as churn, fraud, risk analysis, etc. At 804, the transformation pipeline module 270 selects a transformation. For example, the user request includes a selection of a transformation for inclusion in the transformation pipeline. In some implementations, the transformation may be developed by the user in a programming platform and registered in the transformation library. The transformation may be a complex transformation composed of multiple individual, simpler transformations. For example, a user-developed transformation may be composed of column extraction transformation, column addition transformation, column subtraction transformation, etc. In some implementations, the transformation can be a subset of one or more transformations exported from another transformation pipeline (i.e., transformation workflow) operated on a different dataset.

At 806, the transformation pipeline module 270 identifies pre-conditions and post-conditions of the transformation. In some implementations, the pre-conditions and the post-conditions of the transformation are based on the input and output data associated with executing the transformation. For example, the transformation may have a pre-condition indicating that columnar data or feature A must be numeric and less than zero. In another example, the transformation may have a pre-condition that the transformation accepts a feature A of integer data type and feature B of double data type as input and the post-condition may be that the transformation outputs a feature C of double data type.

At 808, the dataset metadata module 250 identifies a dataset of the transformation pipeline. In some implementations, the dataset metadata module 250 scans the dataset to aggregate metadata present in the storage format of the dataset. For example, the dataset metadata module 250 stores the syntactic data types of the columns in the data including Integer, Double, Text, Blob, DateTime, etc. as metadata. In another example, the dataset metadata module 250 stores statistical information for all columns of the dataset (e.g. when the columns are numerical/continuous type columns) including min, max, mean, standard deviation, normal distribution, etc. and dictionaries specific to categorical type columns. At 810, the transformation pipeline module 270 validates the pre-conditions and post-conditions of the transformation based on the dataset. For example, the transformation pipeline module 270 determines constraints of the input data needed and the output produced by the transformation as the pre-conditions and post-conditions. The transformation pipeline module 270 evaluates whether the transformation is applicable to one or more columns of the dataset by validating the transformation compatibility before the transformation can be invoked based on the metadata of the dataset and pre-conditions and post-conditions of the transformation.

At 812, the transformation pipeline module 270 includes the transformation in the transformation pipeline. In some implementations, if the transformation is found compatible, the transformation pipeline module 270 retrieves information about the transformation from the transformation library. For example, usage scores and applicability scores of the transformation. In some implementations, the transformation pipeline module 270 monitors the execution of the transformation in the transformation pipeline and aggregates performance statistics and metrics for the transformation. For example, progress metrics, usage metrics, error or failure metrics, etc.

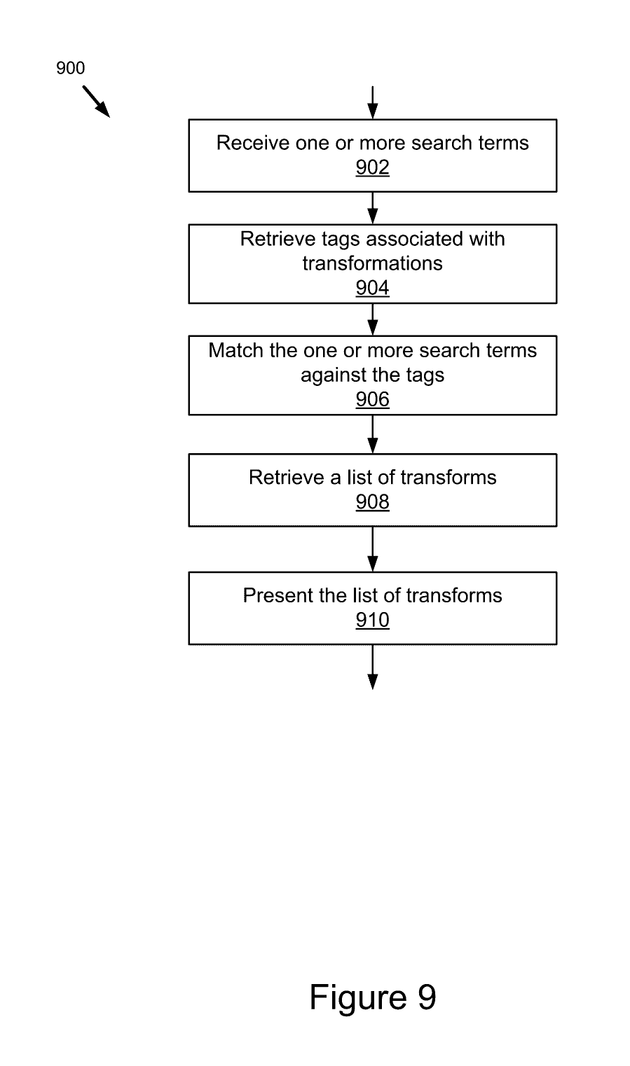

FIG. 9 is a flowchart of an example method 900 for retrieving a list of transformations matching a search for a transformation. At 902, the transformation representation module 260 receives one or more search terms. For example, the search request may include one or more search terms from the user searching for a transformation. In some implementations, the transformation library may serve as a transformation community where users may share their transformations with the community and/or use transformations made available by other users of the community.

At 904, the transformation representation module 260 retrieves tags associated with transformations. In some implementations, the transformation representation module 260 generates tags for the one or more transformations to allow easy identification of connection compatibility between different transformations. The transformation representation module 260 may generate the tags for a transformation based on identification and meta-analysis of key input and output features of the transformation. The tags may be associated with the transformation in the transformation library. The tags may be used for classifying the transformations. In some implementations, the transformation representation module 260 organizes the tags in a hierarchical fashion to support the hierarchical organization or categorization of transformations in the transformation library. For example, the transformations for supervised model generation and unsupervised model generation may be categorized under model generation transformation.

At 906, the transformation representation module 260 matches the one or more search terms against the tags. At 908, the transformation representation module 260 retrieves a list of transformations from the transformation library. At 910, the transformation representation module 260 presents the list of transformations. In some implementations, the list of transformations retrieved may be ranked according to the usage scores and applicability scores.

It should be understood that while FIGS. 8-9 include a number of steps in a predefined order, the methods need not perform all of the steps or perform the steps in the same order. The methods may be performed with any combination of the steps (including fewer or additional steps) different than that shown in FIGS. 8-9. The methods may perform such combinations of steps in any order.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A method comprising:
receiving a first transformation utilizing a first programming platform;
receiving information about the first transformation;
wrapping the first transformation;
including the wrapped, first transformation in a transformation pipeline, the transformation pipeline including a second transformation that is wrapped, the second transformation utilizing a second programming platform different from the first programming platform; and
executing the transformation pipeline including the wrapped, first transformation and the wrapped, second transformation in batch mode or real-time streaming mode.

2. The method of claim 1, wherein one or more of the first programming platform and the second programming platform is one of SAS™, Python™, Apache Spark™, PySpark, Java™, Scala, C++ and R.

3. The method of claim 1, wherein the information about the first transformation includes metadata provided by a user regarding at least one input of the received, first transform and at least one output of the first transform, wherein the at least one input includes one or more of an input parameter, input data, an input data type and a precondition, and wherein the at least one output includes one or more of an output parameter, output data, an output data type and a post-condition.

4. The method of claim 1 further comprising:
receiving a selection of the transformation pipeline;
receiving a selection of the first transformation;
identifying pre-conditions and post-conditions of the first transformation from the information about the first transformation;
identifying a dataset of the transformation pipeline;
validating the pre-conditions and post-conditions of the first transformation based on the dataset; and
including the wrapped first transformation in the transformation pipeline based on the validation.

5. The method of claim 1, wherein the first transformation includes a subset of one or more transformations from another transformation pipeline exported by a user.

6. The method of claim 1, wherein the first transformation is developed using the first programming platform by a user and included in a transformation library.

7. The method of claim 1, wherein the first transformation includes one or more from a group of machine learning model transformation, report transformation and plot transformation.

8. The method of claim 1, further comprising providing information about the transformation to schedule the transformation responsive to validating the pre-conditions and post-conditions of the transformation.

9. The method of claim 8, wherein the provided information about the transformation to schedule the transformation includes one from a group of usage scores, applicability scores and cost estimate.

10. The method of claim 1, wherein receiving the selection of the transformation further comprises:
receiving one or more search terms;
retrieving tags associated with transformations from a transformation library;
matching the one or more search terms against the tags; and
retrieving a list of transformations from the transformation library.

11. A system comprising:
one or more processors; and
a memory storing instructions that, when executed by the one or more processors, cause the system to:
receive a first transformation utilizing a first programming platform;
receive information about the first transformation;
wrap the first transformation;
include the wrapped, first transformation in a transformation pipeline, the transformation pipeline including a second transformation that is wrapped, the second transformation utilizing a second programming platform different from the first programming platform; and
execute the transformation pipeline including the wrapped, first transformation and the wrapped, second transformation in batch mode or real-time streaming mode.

12. The system of claim 11, wherein one or more of the first programming platform and the second programming platform is one of SAS™, Python™, Apache Spark™, PySpark, Java™, Scala, C++ and R.

13. The system of claim 11, wherein the information about the first transformation includes metadata provided by a user regarding at least one input of the received, first transform and at least one output of the first transform, wherein the at least one input includes one or more of an input parameter, input data, an input data type and a precondition, and wherein the at least one output includes one or more of an output parameter, output data, an output data type and a post-condition.

14. The system of claim 11, wherein the instructions, when executed by the one or more processors, further cause the system to:
receive a selection of the transformation pipeline;
receive a selection of the first transformation;
identify pre-conditions and post-conditions of the first transformation from the information about the first transformation;
identify a dataset of the transformation pipeline;
validate the pre-conditions and post-conditions of the first transformation based on the dataset; and
include the wrapped first transformation in the transformation pipeline based on the validation.

15. The system of claim 11, wherein the first transformation includes a subset of one or more transformations from another transformation pipeline exported by a user.

16. The system of claim 11, wherein the first transformation is developed using the first programming platform by a user and included in a transformation library.

17. The system of claim 11, wherein the first transformation includes one or more from a group of machine learning model transformation, report transformation and plot transformation.

18. The system of claim 11, wherein the instructions, when executed by the one or more processors, further cause the system to provide information about the transformation to schedule the transformation responsive to validating the pre-conditions and post-conditions of the transformation.

19. The system of claim 18, wherein the provided information about the transformation to schedule the transformation includes one from a group of usage scores, applicability scores and cost estimate.

20. The system of claim 11, wherein the instructions for receiving the selection of the transformation, when executed by the one or more processors, further cause the system to:
receive one or more search terms;
retrieve tags associated with transformations from a transformation library;
match the one or more search terms against the tags; and
retrieve a list of transformations from the transformation library.
